(19) United States
(12) Patent Application Publication
(10) Pub. No.: US 2004/0211927 A1
(43) Pub. Date: Oct. 28, 2004

(54) Infrared radiator and irradiation apparatus

(75) Inventor: Hans-Joachim Schmidt, Ingolstadt (DE)

Correspondence Address: OSRAM SYLVANIA INC, 100 ENDICOTT STREET, DANVERS, MA, 01923, US

(73) Assignee: PATENT-TREUHAND-GESELLSCHAFT FUR ELEKTRISCHE GLUHLAMPEN MBH, MUNCHEN (DE)

(21) Appl. No.: 10/825,167

(22) Filed: Apr. 16, 2004

(30) Foreign Application Priority Data
Apr. 25, 2003 (DE) 103 19 008.2

(51) Int. Cl. H01K 1/26

(52) U.S. Cl. 250/504 R

(57) ABSTRACT

The invention relates to an infrared radiator, whose radiation source is a luminous element emitting light and IR radiation, and whose vessel which surrounds said luminous element is coated with an interference filter which is transparent only to infrared radiation from a specific subrange from the wavelength range of 700 nm to 3500 nm. Electromagnetic radiation outside the subrange is reflected back into the vessel.

### I. TECHNICAL FIELD

The invention relates to an infrared radiator having a luminous element for producing infrared radiation which is arranged in the interior of a vessel which is permeable to infrared radiation, said vessel having a region which surrounds said interior and at least one closed end which is connected to this region, and the vessel being coated with an interference filter. In addition the invention relates to an irradiation apparatus having such an infrared radiator.

### II. BACKGROUND ART

Such an infrared radiator is disclosed, for example, in the European laid-open specification EP 1 072 841 A2. This specification describes an infrared radiator whose design is essentially similar to that of an incandescent lamp. Acting as the infrared radiation source is an incandescent filament which emits both infrared radiation and light during operation. The infrared radiator is surrounded by a parabolic reflector which directs the infrared radiation in the desired direction and transmits visible radiation. The reflector opening is covered by a non-transparent filter disk. The vessel of the infrared radiator which surrounds the incandescent filament is provided in the region of the dome with a light-reflecting coating which is preferably in the form of a cold-light mirror.

### III. DISCLOSURE OF THE INVENTION

It is the object of the invention to provide an efficient infrared radiator which has as simple a design as possible.

This object is achieved according to the invention by an infrared radiator having a luminous element for producing infrared radiation which is arranged in the interior of a vessel which is permeable to infrared radiation, said vessel having a region which surrounds the interior and having at least one closed end which is connected to this region, and the vessel being coated with an interference filter, wherein said interference filter extends at least over the entire region which surrounds said interior, and the interference filter is designed such that it is transparent to infrared radiation of a predetermined subrange from the wavelength range of 700 nm to 3500 nm, and radiation emitted by the luminous element from the visible spectral range and infrared radiation outside the predetermined wavelength range is reflected back into the interior of the vessel. Particularly advantageous features of the invention are disclosed in the dependent patent claims.

The infrared radiator according to the invention has a luminous element for producing infrared radiation which is arranged in the interior of a vessel which is permeable to infrared radiation. The vessel has a region which surrounds the interior and at least one closed end which is connected to this region. In addition, the vessel is coated with an interference filter which extends according to the invention at least over the entire region of the vessel which surrounds the interior and is designed such that it is transparent to infrared radiation of a predetermined subrange from the wavelength range of 700 nm to 3500 nm, and radiation emitted by the luminous element from the visible spectral range and infrared radiation outside the predetermined wavelength range is reflected back into the interior of the vessel. The abovementioned interference filter ensures that essentially only infrared radiation from the desired wavelength range is emitted by the infrared radiator according to the invention. The visible radiation generated by the luminous element and the undesired infrared radiation are reflected back into the interior of the vessel and serve the purpose of heating up the luminous element. This increases the efficiency of the infrared radiator and means that the light generated by the luminous element and the undesired portion of the infrared radiation is largely prevented from being emitted without the need for further auxiliary means.

The interference filter is preferably in the form of a coating on the outer surface of the vessel in order to prevent the interference filter from being damaged by a chemical reaction with the substances enclosed in the vessel. Advantageously used as the infrared radiation source is either an incandescent element, preferably an incandescent filament, or a gas discharge in xenon. Although these infrared radiation sources are luminous elements since they also produce light in addition to the desired infrared radiation, it has been shown that a higher efficiency can be achieved with them than with other infrared radiation sources. In accordance with a particularly preferred exemplary embodiment of the invention, for this purpose the incandescent element is preferably heated to a temperature of at least 2900° C. during operation of the infrared radiator at its rated operational data.

The vessel of the infrared radiator is advantageously axially symmetrical, and the incandescent element which is preferably in the form of an incandescent filament is aligned axially in the vessel in order to ensure that the incandescent element is heated up in an optimum manner by the radiation which is reflected back into the interior by the interference filter and by the light which is reflected back into the interior. The region of the vessel which surrounds the interior is preferably in the form of an ellipsoid in order to minimize the angular dependence of the reflection on the interference filter such that the thickness of the interference filter can remain essentially constant over the entire region.

The predetermined subrange from the wavelength range of 700 nm to 3500 nm in which the interference filter is transparent depends on the use of the infrared radiator according to the invention. If the infrared radiator according to the invention is to be used for photographic cameras with infrared film, the transparent subrange advantageously extends from 720 nm to 920 nm. For use in electronic cameras having silicon-based semiconductor image sensors, the transparent subrange of the interference filter advantageously extends from 800 nm to 1000 nm. For use in electronic cameras having indium/gallium/arsenide-based (InGaAs-based) semiconductor image sensors, the transparent subrange of the interference filter advantageously extends from 800 nm to 2000 nm. For use as heat radiators, the transparent subrange of the interference filter advantageously extends from 800 nm to 1200 nm. For use in water boilers or dryers, the transparent subrange of the interference filter advantageously extends from 2500 nm to 3500 nm. The interference filter is designed such that its transmission in the transparent subrange is at least 80% of the radiation emitted in this subrange by the radiation source and its transmission is at most 10% at wavelengths outside the transparent subrange. The transparency to electromagnetic radiation of shorter wavelengths than those from the transparent subrange is preferably even markedly lower than 10%. For light it is preferably only 0.1%.

In order to achieve directed emission of the infrared radiation produced by the infrared radiator according to the invention, the radiator may advantageously be used in an irradiation apparatus having a reflector which surrounds the infrared radiator. A suitable reflector is a parabolic metal element, for example made of aluminum, or a parabolic plastic or glass element, which is provided on the inside with a metal layer.

### IV. BRIEF DESCRIPTION OF THE DRAWINGS

The invention will be explained in more detail below with reference to a preferred exemplary embodiment. In the drawing:

FIG. 1 shows a side view of an infrared radiator according to the preferred exemplary embodiment of the invention,

FIG. 2 shows an irradiation apparatus having the infrared radiator depicted in FIG. 1, and

FIG. 3 shows a side view of an infrared radiator according to a second exemplary embodiment of the invention.

### V. BEST MODE FOR CARRYING OUT THE INVENTION

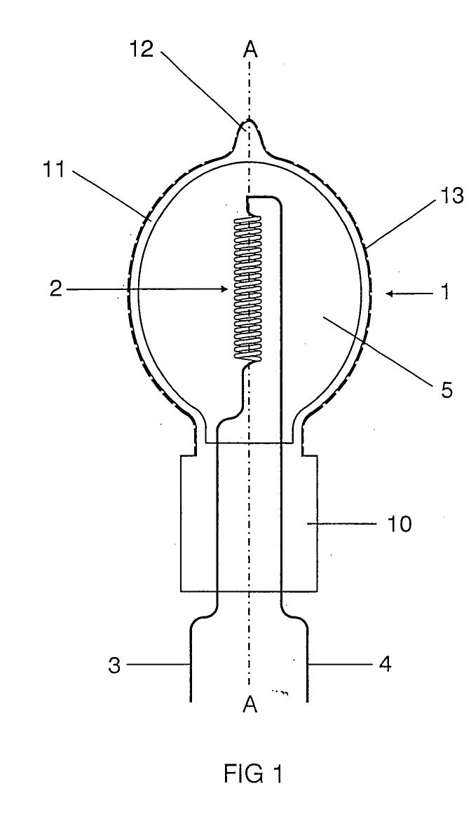

The infrared radiator depicted schematically in FIG. 1 is essentially a halogen incandescent lamp having an electrical power consumption of approximately 50 watts. It has a silica-glass vessel 1 which is sealed off at one end and is provided with dopants absorbing ultraviolet radiation. A tungsten incandescent filament 2 is arranged in the interior of the vessel 1 and is supplied with electrical power by means of two power supply lines 3, 4 protruding from the sealed-off end 10 of the vessel 1. The region 11 which surrounds the interior 5 of the vessel 1, i.e. the region of the vessel apart from the sealed-off end 10 and the dome 12 lying opposite the sealed-off end 10, essentially has the form of an ellipsoid which is rotationally symmetrical with respect to the longitudinal axis A-A of the halogen incandescent lamp or of the infrared radiator. The dome 12 of the vessel 1 is formed by the sealed-off exhaust tube. The incandescent filament 2 is arranged axially in the ellipsoidal region. The outer surface of the ellipsoidal region 11 and the dome 12 of the vessel 1 are coated with an interference filter 13 which is transparent essentially only to infrared radiation from the wavelength range of 800 nm to 1000 nm. The light emitted by the incandescent filament 2 during operation and the infrared radiation which is generated by it and lies outside the transparent wavelength range are reflected back essentially to the incandescent filament 2 by the interference filter 13 and serve the purpose of heating up said incandescent filament 2. The interference filter 13 is made up, in a known manner, from a large number of SiO₂ and TiO₂ layers having alternately low and high optical refractive indices. In order to further reduce the transparency in the shortwave range below 800 nm, in particular to light, the interference filter 13 may also comprise absorber layers, for example made of Fe₂O₃. The transparency of the interference filter 13 is approximately 0.1% of the light emitted by the incandescent filament 2. The incandescent filament 2 is heated during operation to a temperature of 2900° C.

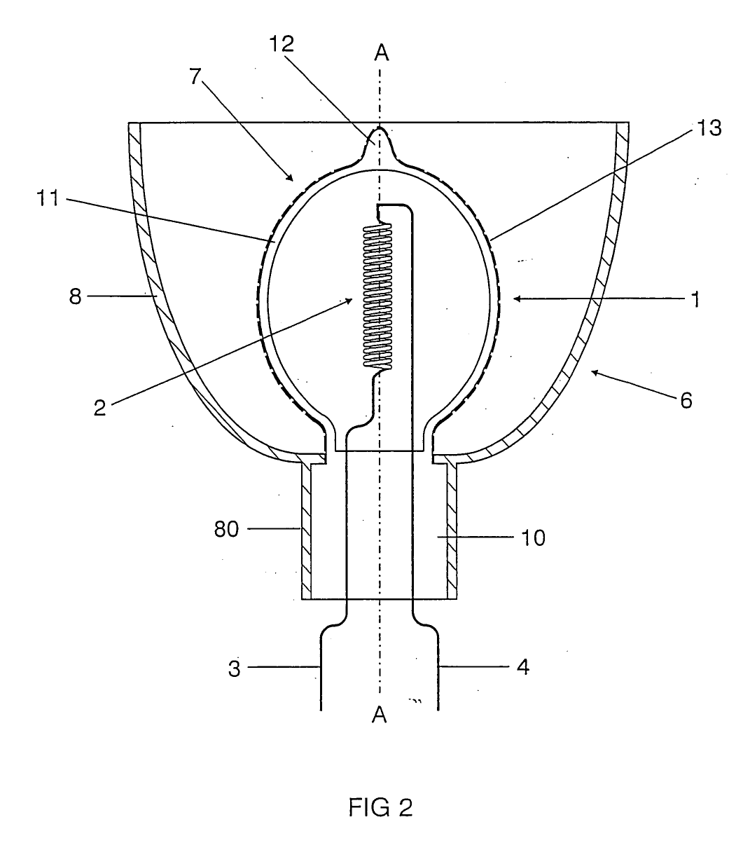

FIG. 2 shows a schematic representation of an irradiation apparatus 6 according to the invention which essentially comprises the infrared radiator 7 depicted in FIG. 1 and a parabolic aluminum reflector 8. In addition, the irradiation apparatus 6 may, if required, comprise cooling means, for example a ventilator. The sealed-off end 10 of the infrared radiator 7 is inserted into the reflector neck 80 such that the infrared radiator 7 is arranged on the axis of symmetry of the aluminum reflector 8. The infrared radiation generated by the infrared radiator 7 is deflected by the aluminum reflector 8 in a direction parallel to the axis of symmetry of the reflector 8. This irradiation apparatus 6 is suitable, for example, as an infrared radiation source for an infrared upper beam in motor vehicles.

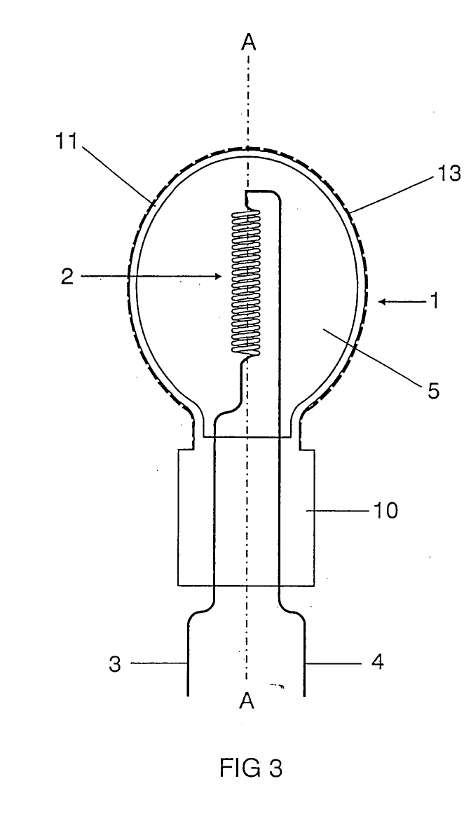

FIG. 3 shows, schematically, a second exemplary embodiment of an infrared radiator according to the invention. This infrared radiator is largely identical to the infrared radiator according to the first exemplary embodiment. Only the shape of the vessel 1 in the region of the dome lying opposite the sealed-off end 10 is different from that in the first exemplary embodiment. For this reason, the same reference numerals have been used for identical parts of the infrared radiator in FIGS. 1 and 3. In contrast to the infrared radiator shown in FIG. 1, the vessel 1 of the infrared radiator depicted in FIG. 3 has no exhaust tube attachment 12. The vessel 1 is evacuated and the halogen filling is introduced via the end 10 of the vessel 1 before it is sealed off, for example by the abovementioned manufacturing steps being carried out within a protective gas atmosphere in clean room conditions. Alternatively, an exhaust tube (not depicted) may also be used which is arranged between the power supply lines 3, 4 in the sealed-off end 10.

What is claimed is:

1. An infrared radiator having a luminous element for producing infrared radiation which is arranged in the interior of a vessel which is permeable to infrared radiation, the vessel having a region which surrounds said interior and at least one closed end which is connected to said region, and said vessel being coated with an interference filter, wherein
said interference filter extends at least over said entire region which surrounds said interior, and said interference filter is designed such that it is transparent to infrared radiation of a predetermined subrange from the wavelength range of 700 nm to 3500 nm, and radiation emitted by the luminous element from the visible spectral range and infrared radiation outside the predetermined wavelength range is reflected back into the interior of said vessel.

2. The infrared radiator as claimed in claim 1, wherein said interference filter is in the form of a coating on the outer surface of the vessel.

3. The infrared radiator as claimed in claim 1, wherein said luminous element comprises at least one incandescent element.

4. The infrared radiator as claimed in claim 3, wherein the material, the geometry and the dimensions of said at least one incandescent element are selected such that the incandescent element has a temperature of at least 2900° C. during operation of the infrared radiator at its rated operational data.

5. The infrared radiator as claimed in claim 3, wherein said at least one incandescent element is an incandescent filament.

6. The infrared radiator as claimed in claim 5, wherein said vessel is axially symmetrical, and said at least one incandescent filament is aligned axially within the vessel.

7. The infrared radiator as claimed in claim 6, wherein said region of the vessel which surrounds said interior is in the form of an ellipsoid.

8. The infrared radiator as claimed in claim 1, wherein said predetermined subrange extends from 720 nm to 920 nm.

9. The infrared radiator as claimed in claim 1, wherein said predetermined subrange extends from 800 nm to 1000 nm.

10. The infrared radiator as claimed in claim 1, wherein said predetermined subrange extends from 800 nm to 1200 nm.

11. The infrared radiator as claimed in claim 1, wherein said predetermined subrange extends from 800 nm to 2000 nm.

12. The infrared radiator as claimed in claim 1, wherein said predetermined subrange extends from 2500 nm to 3500 nm.

13. The infrared radiator as claimed in claim 1, wherein said luminous element is a gas discharge in xenon.

14. An irradiation apparatus having the infrared radiator as claimed in claim 1.

15. The irradiation apparatus as claimed in claim 14, having a reflector for infrared radiation which surrounds said infrared radiator.
